(19) United States
(12) Patent Application Publication
(10) Pub. No.: US 2025/0348944 A1
(43) Pub. Date: Nov. 13, 2025

(54) SYSTEMS AND METHODS FOR INSURANCE RATING BASED ON TELEMATICS

(71) Applicant: Allstate Insurance Company, Northbrook, IL (US)

(72) Inventors: Meg G. Walters, Northbrook, IL (US); Dean Corry, Northbrook, IL (US)

(21) Appl. No.: 18/662,397

(22) Filed: May 13, 2024

(51) Int. Cl. G06Q 40/08

(52) U.S. Cl. CPC G06Q 40/08

(57) ABSTRACT

Systems and methods for intelligent adjustable price-per-metric rate determination include receiving telematics data comprising one or more telematics factors associated with one or more vehicles; based on the telematics data, determining a price-per-metric rate of insurance for a user of a user vehicle of the one or more vehicles; and assigning the price-per-metric rate of insurance to the user for the user vehicle.

### TECHNICAL FIELD

The present disclosure relates to systems and methods for insurance rating and, in particular, systems and methods for a price-per-metric ratio-based insurance plan based on telematics factors independent of user-based factors.

### BACKGROUND

Insurance rating plans may be priced based on factors dependent on a user of a vehicle to be insured to determine a flat rate plan for the user. However, such plans may not meet specific adaptable needs of a user or take into account outside variables. Rather, insurance companies may rate insurance plans based on personal factors of the user such as age, marital status, and the like. Accordingly, a need exists for an improved adjustable pricing model for insurance rating plans based on multiple factors.

### BRIEF SUMMARY

According to the subject matter of the present disclosure, a system for intelligent adjustable price-per-metric rate determination may include one or more processors, one or more memory components communicatively coupled to the one or more processors, and machine readable instructions stored in the one or more memory components. The machine readable instructions cause the system to perform at least the following when executed by the one or more processors: receive telematics data comprising one or more telematics factors associated with one or more vehicles; based on the telematics data, determine a price-per-metric rate of insurance for a user of a user vehicle of the one or more vehicles; display, on a graphical user interface (GUI) of a mobile device of the user, (i) the price-per-metric rate of insurance for the user of the user vehicle and (ii) a prompt to accept the price-per-metric rate of insurance; and upon acceptance of the prompt to accept the price-per-metric rate of insurance on the GUI of the mobile device by the user, assign the price-per-metric rate of insurance to the user for the user vehicle.

According to another embodiment of the present disclosure, a system for intelligent adjustable price-per-metric rate determination may include one or more processors, one or more memory components communicatively coupled to the one or more processors, and machine readable instructions stored in the one or more memory components that cause the system to perform at least the following when executed by the one or more processors: receive telematics data comprising one or more telematics factors associated with one or more vehicles; based on the telematics data, determine a price-per-metric rate of insurance for a user of a user vehicle of the one or more vehicles; and assign the price-per-metric rate of insurance to the user for the user vehicle.

According to yet another embodiment of the present disclosure, a method for intelligent adjustable price-per-metric rate determination may include receiving telematics data comprising one or more telematics factors associated with one or more vehicles; based on the telematics data, determining a price-per-metric rate of insurance for a user of a user vehicle of the one or more vehicles; displaying, on a GUI of a mobile device of the user, (i) the price-per-metric rate of insurance for the user of the user vehicle and (ii) a prompt to accept the price-per-metric rate of insurance; and upon acceptance of the prompt to accept the price-per-metric rate of insurance on the GUI of the mobile device by the user, assigning the price-per-metric rate of insurance to the user for the user vehicle.

According to yet another embodiment of the present disclosure, a method for intelligent adjustable price-per-metric rate determination may include receiving telematics data comprising one or more telematics factors associated with one or more vehicles; based on the telematics data, determining a price-per-metric rate of insurance for a user of a user vehicle of the one or more vehicles; and assigning the price-per-metric rate of insurance to the user for the user vehicle.

Although the concepts of the present disclosure are described herein with primary reference to a system for intelligent adjustable price-per-metric rate determination independent of user-based factors such as age, marital status, driving score, and the like, it is contemplated that the concepts will enjoy applicability to any setting for purposes of determination of an insurance plan, including and not limited to fixed rate plans and/or inclusive of user-based factors.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an environment for an intelligent adjustable price-per-metric rate determination solution, according to one or more embodiments shown and described herein;

FIG. 2 illustrates a flowchart process for use with the environment of FIG. 1 to implement the intelligent adjustable price-per-metric rate determination solution, according to one or more embodiments shown and described herein;

FIG. 3 illustrates a computer implemented system including a system for use with the process flow of FIG. 2 and intelligent adjustable price-per-metric rate determination solution via the environment of FIG. 1, according to one or more embodiments shown and described herein.

### DETAILED DESCRIPTION

In embodiments described herein, systems and methods for a price-per-metric ratio-based insurance plan based on telematics factors may include an artificial intelligence (AI) based software application or other intelligent model that is configured to dynamically determine and update an adjustable rate for a price-per-metric ratio-based insurance plan for a user based on telematics factors that are independent of user-based factors such as age, marital status driving score, and the like. The systems and methods for intelligent adjustable price-per-metric rate determination as described herein may thus provide streamlined determinations of improved accuracy over time with more efficient consideration of telematics factor for price-per-metric modeling based on the telematics factors independent of user-based factors, which may improve processing time, capacity, and cost.

The present disclosure is directed to a rating plan for usage based insurance utilizing telematics based factors independent of user-based factors. Such usage based insurance may be based on driving data collected by a device installed in a vehicle or smart device of a user. Examples of usage based insurance include pay-per-metric insurance plans, which may be, as a non-limiting example, pay-per-mile insurance plans. Embodiments herein consider telematics data for such pay-per-metric insurance plans. For pay-per-metric insurance plans, such ratings may be set based on per-metric (e.g., per-mile) risk at periodic increments or in real-time utilizing the telematics data as risk factors. Such ratings may, in aspects, be set by AI algorithms and machine learning models.

As will be described in greater detail below, embodiments herein include considering telematics factors to set usage based insurance such as contextual speed and/or congestion by time of day for an area traveled, contextual speed and/or congestion by road class for a road traveled, vehicle density by time of day in an area the vehicle travels, and/or vehicle features such as vehicle age or type. Time of day may be a 24-hour period broken into, for example, early morning, rush hours, mid-day, evening, and late night. Road class may be split into limited access highways and surface roads. Speeding and driving in congestion on surface roads may be considered to lead to a high per-mile risk (and increased rates) than on highways. Contextual speed by time of day measures vehicle speed relative to a speed limit at different times of the day. Driving at least more than 10 miles per hour (mph) above the speed limit may lead to a higher mile per risk during certain times of the day, leading to an increase in rate in the usage based insurance plan. A higher percentage of driving in congestion (i.e., rush hour and moving 10-30 mph below a speed limit) may be associated with a higher per mile risk as well. Driving in crawling traffic, such as more than below 30 mph below the speed limit, may not be associated with a higher per mile risk due to lower frequency and severity of accidents. Vehicle density by time of day accounts for vehicles of zips codes in which a person drives. High dense areas of travel may result in an increased per-mile risk versus other areas such as rural low dense areas of travel.

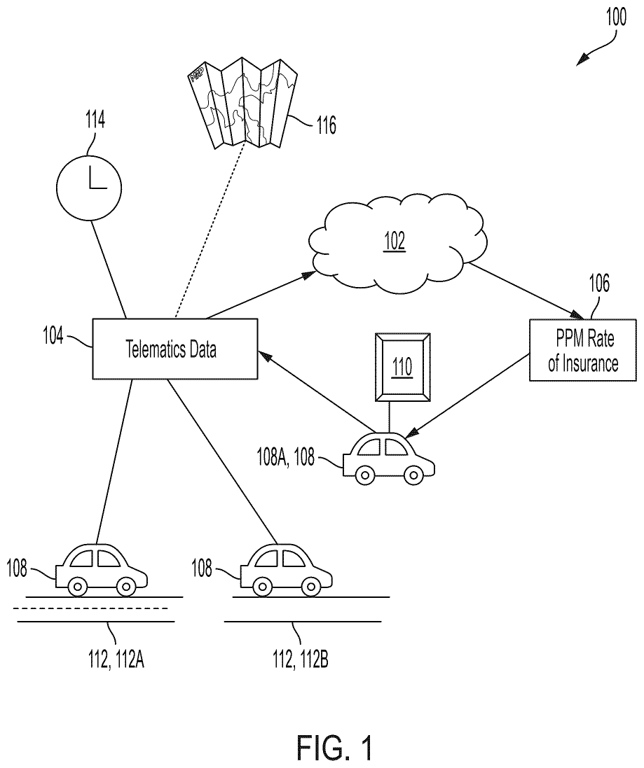

Referring to FIG. 1, an environment 100 is shown for an intelligent adjustable price-per-metric rate determination solution 102 as described, which solution 102 may be an intelligent model, AI based software application, and/or other modular component for intelligent adjustable price-per-metric rate determination (e.g., as a user based insurance) as described herein. The environment 100 includes telematics data 104, one or more vehicles 108 including a user vehicle 108A of a user, a mobile device 110 of the user that may be communicatively coupled to the user vehicle 108A, a type of road 112 including a highway 112A or a surface local road 112B, a time of day input 114, a population area input 116, and a price-per-metric (PPM) determination 106 as an output for the solution 102. The price-per-metric determination 106 may be output to the mobile device 110, the user vehicle 108A, and/or a system 300, described in greater detail further below. In embodiments, the price-per-metric determination 106 may be used to assign a price-per-metric rate of insurance to the user for the user vehicle 108A. The price-per-metric rate of insurance may include a price-per-mile, price-per-day, or price-per-trip rate of insurance.

The telematics data 104 may include one or more telematics factors associated with one or more vehicles 108. In embodiments, the telematics data 104 includes at least one of acceleration data, such as generated by an accelerometer of a vehicle 108 during operation of the one or more vehicles 108, positioning data generated by a global positioning system (GPS) module during operation of the one or more vehicles 108, or speed data generated by the GPS module during operation of the one or more vehicles 108. Such data may be transmitted to the solution 102 via one or more sensors, such as vehicle operational sensors of the one or more vehicles 108 and/or one or more GPS modules of the one or more vehicles 108. The vehicle operational sensors may be configured to collect data regarding one or more vehicle operations such as acceleration, braking, and speed, including hard acceleration or hard braking such as when a rate of acceleration or braking exceeds a threshold associated with a hard level.

In embodiments of the telematics data 104, the one or more telematics factors associated with one or more vehicles 108 may include, for a period of time, (i) miles of the user vehicle 108A (or the one or more vehicles 108) driven on one or more types of roads 112; (ii) miles driven during one or more segmented times periods within a day (e.g., received as the time of day input 114); (iii) miles of the user vehicle 108A (or the one or more vehicles 108) driven in one or more types of population areas (e.g., received as the population area input 116; (iv) hard braking information for the user vehicle 108A (or the one or more vehicles 108); (v) speeding information for the user vehicle 108A (or the one or more vehicles 108); or (vi) combinations thereof. The telematics data 104 may aggregate telematics factors across the one or more vehicles 108.

The population area input 116 may include one or more types of population areas. The one or more types of population areas may include a high population area at or over a population threshold or a low population area under the population threshold. The one or more types of population areas may include one or more types of vehicle density population areas indicative of a level of vehicle congestion, one or more types of human density population areas indicative of a level of vehicle congestion, or combinations thereof, within a population area, such as within one or more zip codes and/or with respect to a portion of one or more types of roads 112 (such as a highway 112A or a surface local road 112B).

In some embodiments of the telematics data 104, the one or more telematics factors associated with one or more vehicles 108 may include, for a period of time, a type of road 112 driven on by the one or more vehicles, a vehicle density (e.g., as the population area input 116) of one or more areas driven in by the one or more vehicles 108, a speed driven by the one or more vehicles 108, and a time of day of driving during the period of time for each of the one or more vehicles 108 (e.g., as the time of day input 114).

The time of day input 114 may be defined by the one or more segmented time periods within the day including during the day or at night. In aspects, the time of day is defined by a plurality of time windows within a 24-hour day period. The plurality of time windows within the 24-hour day period may each comprise a three hour time window defining eight windows as the plurality of time windows. The plurality of time windows within the 24-hour day period may comprise at least one of an early morning window, one or more rush hour windows, a mid-day window, an evening window, and a late night window. Telematics factors of the telematics data 104 to set the price-per-metric determination 106 may include contextual speed and/or congestion by time of day for an area traveled, combining the time of day input 114 and the population area input 116 and potentially the type of road 112 factors. Additionally or alternatively, in other combinations, telematics factors of the telematics data 104 to set the price-per-metric determination 106 may include contextual speed and/or congestion by road class for a road traveled, vehicle density by time of day in an area the user vehicle 108A travels, and/or vehicle features such as vehicle age or type of the user vehicle 108A.

Different contextual factors may be weighted different such that a higher weight for the price-per-metric determination 106 is given to a first class of contextual factor than a second class of contextual factor. By way of example, and not as a limitation, speeding and driving in congestion on surface local roads 112B as the first class of contextual factor may be considered to lead to a high per-mile risk (and increased rates) than on highways 112A as the second class of contextual factor. The telematics factors of the telematics data 104 as described herein may be divided into a plurality of classes of contextual factors that may have some classes be weighted differently and some classes be weighted the same when considered for the price-per-metric determination 106. As a non-limiting example, high dense areas of travel as the first class of contextual factor may result in an increased per-mile risk, and thus have a higher weight, versus other areas such as rural low dense areas of travel as a second class of contextual factor having a weight lower than the higher weight for the price-per-metric determination 106.

In some embodiments of the telematics data 104, the one or more telematics factors associated with one or more vehicles 108 may include, for a period of time, (i) a contextual speed by time of day reflective of a vehicle speed of the user vehicle 108A at a threshold over a speed limit at a specified time of day (e.g., as the time of day input 114); (ii) vehicle congestion of an area (e.g., as the population area input 116) by time of day (e.g., as the time of day input 114) based on the speed driven by the user vehicle 108A; and (iii) one or more features of the user vehicle 108A including, but not limited to, age, class, style, weight, or combinations thereof. In aspects, contextual speed by time of day measures vehicle speed relative to a speed limit at different times of the day. In an embodiment, driving at least more than 10 miles per hour (mph) above the speed limit may lead to a higher mile per risk during certain times of the day as classes of contextual factors, leading to an increase in rate in the price-per-metric determination 106. A higher percentage of driving in congestion (i.e., rush hour and moving 10-30 mph below a speed limit) as other classes of contextual factors may be associated with a higher per mile risk as well, leading to an increase in rate in the price-per-metric determination 106. Driving in crawling traffic, such as more than below 30 mph below the speed limit, may not be associated with a higher per mile risk due to lower frequency and severity of accidents, and thus may decrease or not change a rate in the price-per-metric determination 106.

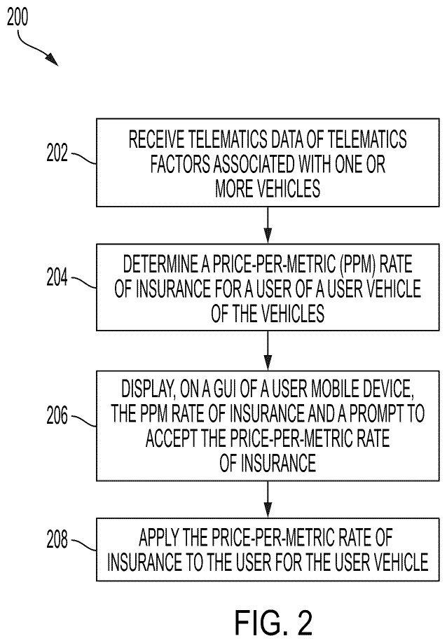

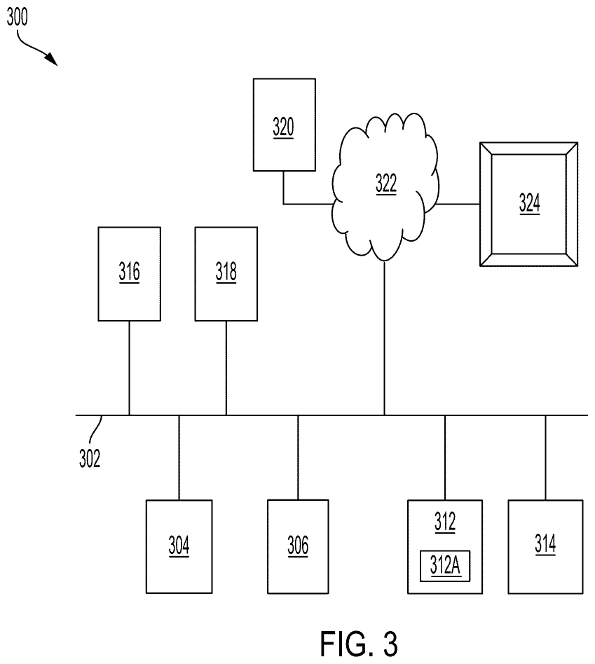

Referring to FIG. 2, an embodiment of a process 200 is shown for use of the intelligent adjustable price-per-metric rate determination solution 102 via the environment 100 of FIG. 1 (as implemented by a system 300 of FIG. 3, described in greater detail below). In block 202, telematics data comprising one or more telematics factors associated with one or more vehicles is received, such as by the system 300. As will be described in greater detail further below, the system 300 may include machine readable instructions stored in one or more memory components 306 communicatively coupled to one or more processors 304, which instructions cause the system 300 to perform a control scheme as described herein, such as the process 200, when executed by the one or more processors 304.

In block 204, based on the telematics data, a price-per-metric rate of insurance for a user of a user vehicle of the one or more vehicles is determined, such as by the system 300. In some embodiments, the system 300 may then advance to block 208, in which the price-per-metric rate of insurance is assigned to the user for the user vehicle. In embodiments including both block 204 advancing directly to block 208, and not including block 206 for user input, a digital insurance card associated with the price-per-metric rate of insurance as assigned to the user may be displayed, such as on the GUI of the mobile device 110 of the user and/or other GUI of the system 300 described herein, upon assignment of the price-per-metric rate of insurance to the user. In embodiments, the process 200 may determine whether a change outside a threshold has occurred with respect to the one or more telematics factors of the telematics data 104, update the price-per-metric rate of insurance when the change outside the threshold has occurred, and assign the updated price-per-metric rate of insurance to the user for the user vehicle 108A. An updated digital insurance card associated with the updated price-per-metric rate of insurance as assigned to the user may be displayed, such as on the GUI of the mobile device 110 of the user and/or other GUI of the system 300 described herein.

In other embodiments, after block 204, the system 300 may advance to block 206. In block 206, the process 200 displays on a GUI of a mobile device of the user, (i) the price-per-metric rate of insurance for the user of the user vehicle and (ii) a prompt to accept the price-per-metric rate of insurance.

In block 208 after block 206 is applied, upon acceptance of the prompt to accept the price-per-metric rate of insurance on the GUI of the mobile device by the user, the price-per-metric rate of insurance is assigned to the user for the user vehicle.

In embodiments including both block 206 and block 208, a digital insurance card associated with the price-per-metric rate of insurance as assigned to the user may be displayed, such as on the GUI of the mobile device 110 of the user and/or other GUI of the system 300 described herein, upon acceptance of the prompt to accept the price-per-metric rate of insurance on the GUI of the mobile device 110 by the user and assignment of the price-per-metric rate of insurance to the user. In embodiments including both block 206 and block 208, the process may further determine whether a change outside a threshold has occurred with respect to the one or more telematics factors of the telematics data 104, update the price-per-metric rate of insurance when the change outside the threshold has occurred, and assign the updated price-per-metric rate of insurance to the user for the user vehicle 108A. An updated digital insurance card associated with the updated price-per-metric rate of insurance as assigned to the user may be displayed on the GUI of the mobile device 110 and/or other GUIs of the system 300.

In further embodiments including both block 206 and block 208, the process 200 may include determining whether a change outside a threshold has occurred with respect to the one or more telematics factors of the telematics data 104, updating the price-per-metric rate of insurance as an updated price-per-metric rate of insurance when the change outside the threshold has occurred, and display, on the GUI of the mobile device 110 of the user, (i) the updated price-per-metric rate of insurance for the user of the user vehicle 108A and (ii) a prompt to accept the updated price-per-metric rate of insurance. Upon acceptance of the prompt to accept the updated price-per-metric rate of insurance on the GUI of the mobile device 110 by the user, the updated price-per-metric rate of insurance may be assigned to the user for the user vehicle 108A. An updated digital insurance card associated with the price-per-metric rate of insurance as assigned to the user may be displayed upon acceptance of the prompt to accept the updated price-per-metric rate of insurance on the GUI of the mobile device 110 by the user.

In embodiments, the process 200 may include determining whether the change outside the threshold has occurred with respect to the one or more telematics factors of the telematics data 104 in real-time. The price-per-metric rate of insurance may be updated in real-time when the change outside the threshold has occurred. Additionally or alternatively, the process 200 may include determining whether the change outside the threshold has occurred with respect to the one or more telematics factors of the telematics data within a periodic interval. The price-per-metric rate of insurance may be updated at an end of the periodic interval when the change outside the threshold has occurred. The periodic interval may be hourly, daily, weekly, monthly, quarterly, or other type of periodic interval.

FIG. 3 illustrates a computer implemented system 300 for use with the process 200 of FIG. 2 and the environment 100 of FIG. 1. Referring to FIG. 3, a non-transitory system 300 is shown for implementing a computer and software-based method, such as directed by the environment 100 and the process 200, for intelligent adjustable price-per-metric rate determination as described herein. The system 300 comprises a communication path 302, one or more processors 304, a non-transitory memory component 306, a rate determination module 312, a telematics sub-module 312A of the rate determination module 312, a storage or database 314, a machine learning module 316, a network interface hardware 318, a network 322, a server 320, and a computing device 324 communicatively coupled to one or more GUIs. The various components of the system 300 and the interaction thereof will be described in detail below.

While only one server 320 and one computing device 324 are illustrated, the system 300 can comprise multiple servers containing one or more applications and computing devices. In some embodiments, the system 300 is implemented using a wide area network (WAN) or network 322, such as an intranet or the internet. The computing device 324 may include digital systems and other devices permitting connection to and navigation of the network. It is contemplated and within the scope of this disclosure that the computing device 324 may be a personal computer, a laptop device, a smart mobile device (e.g., the mobile device 110 of FIG. 1) such as a smart phone or smart pad, or the like. Other system 300 variations allowing for communication between various geographically diverse components are possible. The lines depicted in FIG. 3 indicate communication rather than physical connections between the various components.

The system 300 comprises the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the intelligent acceptability system 300. As used herein, the term “communicatively coupled” means that coupled components are capable of exchanging data signals with one another such as, for example, electrical signals via conductive medium, electromagnetic signals via air, optical signals via optical waveguides, and the like.

The intelligent acceptability system 300 of FIG. 3 also comprises the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

The illustrated system 300 further comprises the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor 304, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, as noted above, the system 300 comprises the display such as the GUI on a screen of the computing device 324 for providing visual output such as, for example, information, graphical reports, messages, or a combination thereof. The display on the screen of the computing device 324 is coupled to the communication path 302 and communicatively coupled to the processor 304. Accordingly, the communication path 302 communicatively couples the display to other modules of the intelligent acceptability system 300. The display can comprise any medium capable of transmitting an optical output such as, for example, a cathode ray tube, light emitting diodes, a liquid crystal display, a plasma display, or the like. Additionally, it is noted that the display or the computing device 324 can comprise at least one of the processor 304 and the memory component 306. While the system 300 is illustrated as a single, integrated system in FIG. 3, in other embodiments, the systems can be independent systems.

The system 300 comprises the rate determination module 312 as described above to at least determine a price-per-metric rate of insurance for a user of a user vehicle 108A of the one or more vehicles 108 based upon telematics data 104 including one or more telematics factors associated with one or more vehicles 108 as received and analyzed by the telematics sub-module 312A. The machine learning module 316 communicatively coupled to the rate determination module 312 and the telematics sub-module 312A may include an artificial intelligence component to train and provide machine learning capabilities to a neural network as described herein for intelligent adjustable price-per-metric rate determination.

The rate determination module 312, the telematics sub-module 312A, and the machine learning module 316 are coupled to the communication path 302 and communicatively coupled to the processor 304. As will be described in further detail below, the processor 304 may process the input signals received from the system modules and/or extract information from such signals.

Data stored and manipulated in the system 300 as described herein is utilized by the machine learning module 316, which is able to leverage a cloud computing-based network configuration such as the cloud to apply Machine Learning and Artificial Intelligence. This machine learning application may create models that can be applied by the system 300, to make it more efficient and intelligent in execution. As an example and not a limitation, the machine learning module 316 may include artificial intelligence components selected from the group consisting of an artificial intelligence engine, Bayesian inference engine, and a decision-making engine, and may have an adaptive learning engine further comprising a deep neural network learning engine.

The system 300 comprises the network interface hardware 318 for communicatively coupling the system 300 with a computer network such as network 322. The network interface hardware 318 is coupled to the communication path 302 such that the communication path 302 communicatively couples the network interface hardware 318 to other modules of the intelligent acceptability system 300. The network interface hardware 318 can be any device capable of transmitting and/or receiving data via a wireless network. Accordingly, the network interface hardware 318 can comprise a communication transceiver for sending and/or receiving data according to any wireless communication standard. For example, the network interface hardware 318 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computing device 324 can be provided from the computing device 324 to the system 300 via the network interface hardware 318. The computing device 324 can be any device having hardware (e.g., chipsets, processors, memory, etc.) for communicatively coupling with the network interface hardware 318 and a network 322. Specifically, the computing device 324 can comprise an input device having an antenna for communicating over one or more of the wireless computer networks described above.

The network 322 can comprise any wired and/or wireless network such as, for example, wide area networks, metropolitan area networks, the internet, an intranet, satellite networks, or the like. Accordingly, the network 322 can be utilized as a wireless access point by the computing device 324 to access one or more servers (e.g., a server 320). The server 320 and any additional servers generally comprise processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### Aspects Listing:

Aspect 1. A system for intelligent adjustable price-per-metric rate determination including one or more processors, one or more memory components communicatively coupled to the one or more processors, and machine readable instructions stored in the one or more memory components. The machine readable instructions cause the system to perform at least the following when executed by the one or more processors: receive telematics data comprising one or more telematics factors associated with one or more vehicles; based on the telematics data, determine a price-per-metric rate of insurance for a user of a user vehicle of the one or more vehicles; display, on a graphical user interface (GUI) of a mobile device of the user, (i) the price-per-metric rate of insurance for the user of the user vehicle and (ii) a prompt to accept the price-per-metric rate of insurance; and upon acceptance of the prompt to accept the price-per-metric rate of insurance on the GUI of the mobile device by the user, assign the price-per-metric rate of insurance to the user for the user vehicle.

Aspect 2. The system of Aspect 1, further including machine readable instructions that cause the system to perform at least the following when executed by the one or more processors: display a digital insurance card associated with the price-per-metric rate of insurance as assigned to the user upon acceptance of the prompt to accept the price-per-metric rate of insurance on the GUI of the mobile device by the user.

Aspect 3. The system of Aspect 1 or Aspect 2, further including machine readable instructions that cause the system to perform at least the following when executed by the one or more processors: determine whether a change outside a threshold has occurred with respect to the one or more telematics factors of the telematics data; update the price-per-metric rate of insurance when the change outside the threshold has occurred; and assign the updated price-per-metric rate of insurance to the user for the user vehicle.

Aspect 4. The system of any of Aspect 3, further including machine readable instructions that cause the system to perform at least the following when executed by the one or more processors: display an updated digital insurance card associated with the updated price-per-metric rate of insurance as assigned to the user on the GUI of the mobile device.

Aspect 5. The system of any of Aspect 1 to Aspect 4, further including machine readable instructions that cause the system to perform at least the following when executed by the one or more processors: determine whether the change outside the threshold has occurred with respect to the one or more telematics factors of the telematics data in real-time; and update the price-per-metric rate of insurance in real-time when the change outside the threshold has occurred.

Aspect 6. The system of any of Aspect 1 to Aspect 5, further including machine readable instructions that cause the system to perform at least the following when executed by the one or more processors: determine whether the change outside the threshold has occurred with respect to the one or more telematics factors of the telematics data within a periodic interval; and update the price-per-metric rate of insurance at an end of the periodic interval when the change outside the threshold has occurred.

Aspect 7. The system of any of Aspect 1 to Aspect 6, further including machine readable instructions that cause the system to perform at least the following when executed by the one or more processors: determine whether a change outside a threshold has occurred with respect to the one or more telematics factors of the telematics data; update the price-per-metric rate of insurance as an updated price-per-metric rate of insurance when the change outside the threshold has occurred; display, on the GUI of the mobile device of the user, (i) the updated price-per-metric rate of insurance for the user of the user vehicle and (ii) a prompt to accept the updated price-per-metric rate of insurance; and upon acceptance of the prompt to accept the updated price-per-metric rate of insurance on the GUI of the mobile device by the user, assign the updated price-per-metric rate of insurance to the user for the user vehicle.

Aspect 8. The system of Aspect 7, further including machine readable instructions that cause the system to perform at least the following when executed by the one or more processors: display an updated digital insurance card associated with the price-per-metric rate of insurance as assigned to the user upon acceptance of the prompt to accept the updated price-per-metric rate of insurance on the GUI of the mobile device by the user.

Aspect 9. The system of any Aspect 1 to Aspect 8, wherein the price-per-metric rate of insurance comprises a price-per-mile, price-per-day, or price-per-trip rate of insurance.

Aspect 10. The system of any Aspect 1 to Aspect 9, wherein the one or more telematics factors associated with one or more vehicles comprise, for a period of time, (i) miles of the user vehicle driven on one or more types of roads; (ii) miles driven during one or more segmented times periods within a day; (iii) miles of the user vehicle driven in one or more types of population area; (iv) hard braking information for the user vehicle; (v) speeding information for the user vehicle; or (vi) combinations thereof.

Aspect 11. The system of Aspect 10, wherein the one or more types of roads comprise a highway or a surface local road, the one or more segmented time periods within the day including during the day or at night, and the one or more types of population areas comprise a high population area at or over a population threshold or a low population area under the population threshold.

Aspect 12. The system of Aspect 11, wherein the one or more types of population areas comprise one or more types of vehicle density population areas, one or more types of human density population areas, or combinations thereof.

Aspect 13. The system of any Aspect 1 to Aspect 12, wherein the one or more telematics factors associated with one or more vehicles comprise, for a period of time, a type of road driven on by the one or more vehicles, a vehicle density of one or more areas driven in by the one or more vehicles, a speed driven by the one or more vehicles, and a time of day of driving during the period of time for each of the one or more vehicles.

Aspect 14. The system of Aspect 13, wherein the time of day is defined by a plurality of time windows within a 24-hour day period.

Aspect 15. The system of Aspect 14, wherein the plurality of time windows within the 24-hour day period each comprise a three hour time window defining eight windows as the plurality of time windows.

Aspect 16. The system of Aspect 14 or Aspect 15, wherein the plurality of time windows within the 24-hour day period comprise at least one of an early morning window, one or more rush hour windows, a mid-day window, an evening window, and a late night window.

Aspect 17. The system of any Aspect 1 to Aspect 16, wherein the one or more telematics factors associated with one or more vehicles further comprise, for the period of time, (i) a contextual speed by time of day reflective of a vehicle speed of the user vehicle at a threshold over a speed limit at a specified time of day; (ii) vehicle congestion of an area by time of day based on the speed driven by the user vehicle; and (iii) one or more features of the user vehicle comprising age, class, style, weight, or combinations thereof.

Aspect 18. A system for intelligent adjustable price-per-metric rate determination including one or more processors, one or more memory components communicatively coupled to the one or more processors, and machine readable instructions stored in the one or more memory components that cause the system to perform at least the following when executed by the one or more processors: receive telematics data comprising one or more telematics factors associated with one or more vehicles; based on the telematics data, determine a price-per-metric rate of insurance for a user of a user vehicle of the one or more vehicles; and assign the price-per-metric rate of insurance to the user for the user vehicle.

Aspect 19. The system of Aspect 18, further including machine readable instructions that cause the system to perform at least the following when executed by the one or more processors: determine whether a change outside a threshold has occurred with respect to the one or more telematics factors of the telematics data; update the price-per-metric rate of insurance when the change outside the threshold has occurred; and assign the updated price-per-metric rate of insurance to the user for the user vehicle.

Aspect 20. The system of Aspect 18, further including machine readable instructions that cause the system to perform at least any of the features of any of Aspect 1 to Aspect 17 when executed by the one or more processors.

Aspect 21. A method for intelligent adjustable price-per-metric rate determination may include receiving telematics data comprising one or more telematics factors associated with one or more vehicles; based on the telematics data, determining a price-per-metric rate of insurance for a user of a user vehicle of the one or more vehicles; displaying, on a GUI of a mobile device of the user, (i) the price-per-metric rate of insurance for the user of the user vehicle and (ii) a prompt to accept the price-per-metric rate of insurance; and upon acceptance of the prompt to accept the price-per-metric rate of insurance on the GUI of the mobile device by the user, assigning the price-per-metric rate of insurance to the user for the user vehicle.

Aspect 22. The method of Aspect 21, further including at least any of the features of any of Aspect 1 to Aspect 17.

Aspect 23. A method for intelligent adjustable price-per-metric rate determination may include receiving telematics data comprising one or more telematics factors associated with one or more vehicles; based on the telematics data, determining a price-per-metric rate of insurance for a user of a user vehicle of the one or more vehicles; and assigning the price-per-metric rate of insurance to the user for the user vehicle.

Aspect 24. The method of Aspect 23, further including at least any of the features of any of Aspect 1 to Aspect 17.

1. A system for intelligent adjustable price-per-metric rate determination, the system comprising:
one or more processors;
one or more memory components communicatively coupled to the one or more processors; and
machine readable instructions stored in the one or more memory components that cause the system to perform at least the following when executed by the one or more processors:
receive telematics data comprising one or more telematics factors associated with one or more vehicles;
based on the telematics data, determine a price-per-metric rate of insurance for a user of a user vehicle of the one or more vehicles;
display, on a graphical user interface (GUI) of a mobile device of the user, (i) the price-per-metric rate of insurance for the user of the user vehicle and (ii) a prompt to accept the price-per-metric rate of insurance; and
upon acceptance of the prompt to accept the price-per-metric rate of insurance on the GUI of the mobile device by the user, assign the price-per-metric rate of insurance to the user for the user vehicle.

2. The system of claim 1, further comprising machine readable instructions that cause the system to perform at least the following when executed by the one or more processors:
display a digital insurance card associated with the price-per-metric rate of insurance as assigned to the user upon acceptance of the prompt to accept the price-per-metric rate of insurance on the GUI of the mobile device by the user.

3. The system of claim 1, further comprising machine readable instructions that cause the system to perform at least the following when executed by the one or more processors:
determine whether a change outside a threshold has occurred with respect to the one or more telematics factors of the telematics data;
update the price-per-metric rate of insurance when the change outside the threshold has occurred; and
assign the updated price-per-metric rate of insurance to the user for the user vehicle.

4. The system of claim 3, further comprising machine readable instructions that cause the system to perform at least the following when executed by the one or more processors:
display an updated digital insurance card associated with the updated price-per-metric rate of insurance as assigned to the user on the GUI of the mobile device.

5. The system of claim 3, further comprising machine readable instructions that cause the system to perform at least the following when executed by the one or more processors:
determine whether the change outside the threshold has occurred with respect to the one or more telematics factors of the telematics data in real-time; and
update the price-per-metric rate of insurance in real-time when the change outside the threshold has occurred.

6. The system of claim 3, further comprising machine readable instructions that cause the system to perform at least the following when executed by the one or more processors:
determine whether the change outside the threshold has occurred with respect to the one or more telematics factors of the telematics data within a periodic interval; and
update the price-per-metric rate of insurance at an end of the periodic interval when the change outside the threshold has occurred.

7. The system of claim 1, further comprising machine readable instructions that cause the system to perform at least the following when executed by the one or more processors:
determine whether a change outside a threshold has occurred with respect to the one or more telematics factors of the telematics data;
update the price-per-metric rate of insurance as an updated price-per-metric rate of insurance when the change outside the threshold has occurred;
display, on the GUI of the mobile device of the user, (i) the updated price-per-metric rate of insurance for the user of the user vehicle and (ii) a prompt to accept the updated price-per-metric rate of insurance; and
upon acceptance of the prompt to accept the updated price-per-metric rate of insurance on the GUI of the mobile device by the user, assign the updated price-per-metric rate of insurance to the user for the user vehicle.

8. The system of claim 7, further comprising machine readable instructions that cause the system to perform at least the following when executed by the one or more processors:
display an updated digital insurance card associated with the price-per-metric rate of insurance as assigned to the user upon acceptance of the prompt to accept the updated price-per-metric rate of insurance on the GUI of the mobile device by the user.

9. The system of claim 1, wherein the price-per-metric rate of insurance comprises a price-per-mile, price-per-day, or price-per-trip rate of insurance.

10. The system of claim 1, wherein the one or more telematics factors associated with one or more vehicles comprise, for a period of time, (i) miles of the user vehicle driven on one or more types of roads; (ii) miles driven during one or more segmented times periods within a day; (iii) miles of the user vehicle driven in one or more types of population areas; (iv) hard braking information for the user vehicle; (v) speeding information for the user vehicle; or (vi) combinations thereof.

11. The system of claim 10, wherein the one or more types of roads comprise a highway or a surface local road, the one or more segmented time periods within the day including during the day or at night, and the one or more types of population areas comprise a high population area at or over a population threshold or a low population area under the population threshold.

12. The system of claim 11, wherein the one or more types of population areas comprise one or more types of vehicle density population areas, one or more types of human density population areas, or combinations thereof.

13. The system of claim 1, wherein the one or more telematics factors associated with one or more vehicles comprise, for a period of time, a type of road driven on by the one or more vehicles, a vehicle density of one or more areas driven in by the one or more vehicles, a speed driven by the one or more vehicles, and a time of day of driving during the period of time for each of the one or more vehicles.

14. The system of claim 13, wherein the time of day is defined by a plurality of time windows within a 24-hour day period.

15. The system of claim 14, wherein the plurality of time windows within the 24-hour day period each comprise a three hour time window defining eight windows as the plurality of time windows.

16. The system of claim 14, wherein the plurality of time windows within the 24-hour day period comprise at least one of an early morning window, one or more rush hour windows, a mid-day window, an evening window, and a late night window.

17. The system of claim 13, wherein the one or more telematics factors associated with one or more vehicles further comprise, for the period of time, (i) a contextual speed by time of day reflective of a vehicle speed of the user vehicle at a threshold over a speed limit at a specified time of day; (ii) vehicle congestion of an area by time of day based on the speed driven by the user vehicle; and (iii) one or more features of the user vehicle comprising age, class, style, weight, or combinations thereof.

18. A system for intelligent adjustable price-per-metric rate determination, the system comprising:
one or more processors;
one or more memory components communicatively coupled to the one or more processors; and
machine readable instructions stored in the one or more memory components that cause the system to perform at least the following when executed by the one or more processors:
receive telematics data comprising one or more telematics factors associated with one or more vehicles;
based on the telematics data, determine a price-per-metric rate of insurance for a user of a user vehicle of the one or more vehicles; and
assign the price-per-metric rate of insurance to the user for the user vehicle.

19. The system of claim 18, further comprising machine readable instructions that cause the system to perform at least the following when executed by the one or more processors:
determine whether a change outside a threshold has occurred with respect to the one or more telematics factors of the telematics data;
update the price-per-metric rate of insurance when the change outside the threshold has occurred; and
assign the updated price-per-metric rate of insurance to the user for the user vehicle.

20. A method for intelligent adjustable price-per-metric rate determination, the method comprising:
receiving telematics data comprising one or more telematics factors associated with one or more vehicles;
based on the telematics data, determining a price-per-metric rate of insurance for a user of a user vehicle of the one or more vehicles;
displaying, on a graphical user interface (GUI) of a mobile device of the user, (i) the price-per-metric rate of insurance for the user of the user vehicle and (ii) a prompt to accept the price-per-metric rate of insurance; and
upon acceptance of the prompt to accept the price-per-metric rate of insurance on the GUI of the mobile device by the user, assigning the price-per-metric rate of insurance to the user for the user vehicle.
